(19) United States
(12) Patent Application Publication
(10) Pub. No.: US 2013/0055793 A1
(43) Pub. Date: Mar. 7, 2013

(54) FILTER CLOGGING DETECTION APPARATUS

(71) Applicant: Gou Karasuyama, Tokyo (JP)

(72) Inventor: Gou Karasuyama, Tokyo (JP)

(73) Assignee: NEC Display Soulutions, Ltd., Tokyo (JP)

(21) Appl. No.: 13/696,998

(22) PCT Filed: May 19, 2010
(86) PCT No.: PCT/JP2010/058433

§ 371 Date: Nov. 8, 2012

(51) Int. Cl. G01M 3/26

(52) U.S. Cl. 73/37

(57) ABSTRACT

There is provided a filter clogging apparatus capable of detecting clogging of an individual filter without being limited to the direction in which cooling air is taken in. There is provided a filter clogging detection apparatus for detecting clogging in filter (2) for preventing dust contained in cooling air (7) for cooling object (6) to be cooled from passing through the filter. The filter clogging detection apparatus includes: force detector (11) disposed on case (5) in such a way as to abut on the face on the downstream side in the direction of flow of cooling air (7) of filter (2) and for detecting force applied to filter (2) when cooling air (7) passes through filter (2); and clogging determination part (12) determining that clogging is caused in filter (2) when a value detected by the force detector is larger than a predetermined threshold.

### TECHNICAL FIELD

The present invention relates to a filter clogging detection apparatus for detecting clogging of a filter for removing dust floating in cooling air.

### BACKGROUND ART

An electronic instrument or an information processing instrument generally has a heating part disposed in a case of the instrument. As the heating part generates heat, temperature in the case increases and hence the electronic part disposed in the case could be impaired by the heat. For this reason, there has been conventionally known a instrument having a fan disposed therein which forcibly takes in air from the outside through an air suction port that is formed in the case in order to cool the interior of the case.

When an electronic instrument provided with a precision part or an optical part takes cooling air into a case, if the electronic instrument takes dust in the air into the case, the precision part or the optical part is liable to be broken. Hence, in order to remove the dust in the air, some electronic instruments have a filter provided at an air suction port.

In the electronic instrument provided with the filter, if the dust is deposited on the filter to clog the filter, the flow rate of cooling air taken into the case is decreased and hence the cooling capacity is reduced. As a result, the temperature in the case is increased which results in impairing or damaging the electronic part.

For this reason, many filter clogging detection apparatus for detecting clogging of a filter have been proposed. By informing an operator of the electronic instrument about the clogging of the filter to thereby alert the operator to clean or exchange the filter, overheating of the electronic instrument by the clogging of the filter can be prevented.

JP2000-153121A (hereinafter referred to as patent document 1) discloses an apparatus for detecting clogging of a filter by applying a given drive voltage to a drive motor for rotating a fan, and by measuring the number of revolutions of the drive motor. When clogging of the filter is caused, the flow rate of cooling air fed into the case by the fan is decreased, which thus reduces the rotational load applied to the drive motor. Since the drive motor has the constant drive voltage applied thereto, the number of revolutions of the drive motor is increased by a reduction in the rotational load. In other words, when the number of revolutions of the drive motor becomes larger than the reference number of revolutions, clogging of the filter can be recognized.

However, in the filter clogging detection apparatus disclosed in patent document 1, in the case where a plurality of air suction ports are provided and where each of the plurality of air suction ports has a filter, it is impossible to correctly recognize the filter that is clogged. As a result, a filter that is not clogged is also cleaned or exchanged, so that the cleaning time is increased and hence the cost of the filter is easily increased.

JP11-197427A (hereinafter referred to as patent document 2) and P05-137929A (hereinafter referred to as patent document 3) disclose an apparatus for individually detecting clogging of a filter individually by detecting a change in the mass of the filter. FIG. 1 is a section view of the main portion of a filter clogging detection apparatus disclosed in patent document 2.

As shown in FIG. 1, the apparatus for detecting clogging of a filter disclosed in patent document 2 includes cylinder part 1 having a central axis disposed in a vertical direction and a filter 2 disposed in the cylinder part 1 in such a way as to slide along the central axis. Filter 2 is suspended on an inner wall of cylinder part 1 by the use of helix spring 3, and switch 4 such as a micro-switch is disposed below in the vertical direction of filter 2. When dust is deposited on filter 2, the mass of filter 2 is increased to elongate helix spring 2 to make filer 2 activate switch 4, whereby the clogging of filter 2 can be detected.

Patent document 3 discloses a filter clogging detection apparatus having a mass sensor for detecting mass disposed at a portion for supporting filter 2. When dust is deposited on filter 2 and the mass of filter 2 is increased to make the mass sensor become larger than a given threshold, it is recognized that the clogging of filter 2 has occurred.

However, in the apparatus for detecting clogging of a filter disclosed in patent document 2 and patent document 3, a surface from which the dust of filter 2 is removed needs to be arranged in a horizontal direction and filter 2 needs to be set in such a way as to slide in the vertical direction. Here use of the apparatus is limited to the cases where the cooling air is taken in in the vertical direction.

In some of the electronic instruments, for example, like a projector, a direction in which the instrument is set can be changed according to the operating environment. In the case of an electronic instrument like this, the direction in which the filter is set is not constant, so that the detection apparatus disclosed in patent document 2 and patent document 3 cannot be applied to the electronic instrument.

### CITATION LIST

### Patent Document

Patent document 1: JP2000-153121A

Patent document 2: JP11-197427A

Patent document 3: JP05-137929A

### SUMMARY OF INVENTION

Thus, an example of the object of the present invention is to provide a filter clogging detection apparatus that can detect clogging of an individual filter without being limited to the direction in which cooling air is taken in.

To achieve the object described above, an aspect of the present invention is a filter clogging detection apparatus for detecting clogging in a filter for preventing dust that is present in cooling air that cools an object to be cooled from passing through the filter. The filter clogging detection apparatus includes: a force detector disposed on a case in such a way as to abut on a face on a downstream side in a direction of flow of the cooling air of the filter and to detect a force applied to the filter when the cooling air passes through the filter; and a clogging determination part determining that clogging is caused in the filter when a value detected by the force detector is larger than a predetermined threshold.

According to the present invention, the clogging of the individual filter can be detected without being limited to the direction in which the cooling air is taken in.

### BRIEF DESCRIPTION OF THE DRAWINGS

FIG. 1 is a section view of a main portion of a filter clogging detection apparatus in a related art;

FIG. 2 is a schematic view to show a filter clogging detection apparatus in a first exemplary embodiment of the present invention;

FIG. 3 is a schematic view to show a filter clogging detection apparatus in a second exemplary embodiment of the present invention; and

FIG. 4 is a flow chart to show a general operation of the filter clogging detection apparatus in the second exemplary embodiment.

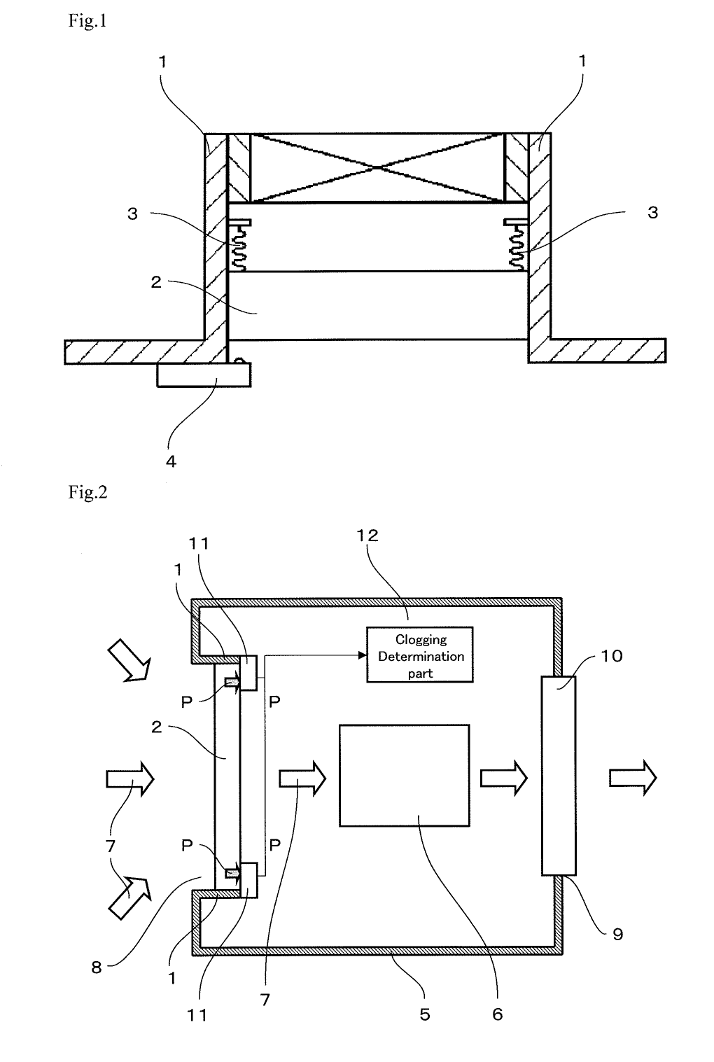

### DESCRIPTION OF EMBODIMENTS

Hereinafter, exemplary embodiments of the present invention will be described in detail with reference to the accompanying drawings.

### Exemplary Embodiment 1

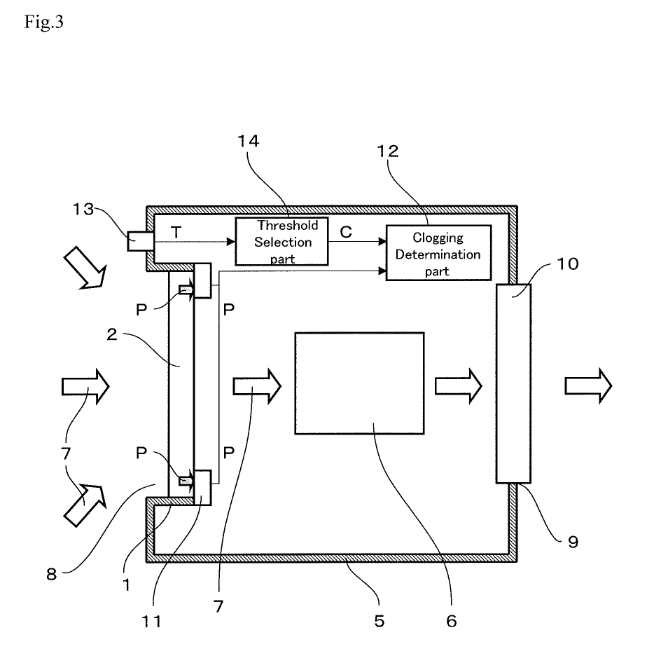

FIG. 2 is a schematic view of an electronic instrument having a filter clogging detection apparatus in a first exemplary embodiment of the present invention. As shown in FIG. 2, the electronic instrument has object 6 to be cooled disposed in case 5 formed in the shape of a box. Object 6 to be cooled includes a heating part that generates heat when the electronic instrument is activated and an electronic part easily impaired by heat.

Case 5 has air suction port 8 and air discharge port 9 formed therein, air suction port 8 taking in cooling air that cools object 6 to be cooled, air discharge port 9 discharging cooling air 7 to the outside of case 5. Fan 10 for producing a flow of cooling air 7 is disposed at air discharge port 9. Air suction port 8 and air discharge port 9 are disposed in such a way that the flow of cooling air 7 passes through object 6 to be cooled, whereby object 6 to be cooled is cooled.

Fan 10 does not need to be disposed at air discharge port 9 but may be disposed in case 5 so as to provide the flow of cooling air 7 flowing to air discharge port 9 from object 6 to be cooled.

Further, case 5 has cylinder part 1 formed on the inside of case 5 from air suction port 8 and the flow of cooling air 7 is provided along cylinder part 1. Filter 2 for preventing dust that is present in cooling air 7 from passing through the filter is disposed in cylinder part 1 in such a way as to slide along the flow of cooling air 7.

By disposing filter 2 in the middle of the flow of cooling air 7, the dust contained in cooling air 7 can be removed. Further, the dust can be removed before cooling air 7 flows into case 5, so that object 6 to be cooled can be cooled without sending the dust into case 5.

When a clearance is formed between cylinder part 1 and filter 2, cooling air 7 containing the dust flows into case 5 from the clearance. For this reason, it is recommended that cylinder 1 be formed in accordance with the shape of filter 2 and to make the clearance between filter 2 and cylinder part 1 small.

Case 5 has a force detector 11 fixed thereto in such a way that the force detector 11 abuts on a face on the downstream side in the direction of the flow of cooling air 7. Force detector 11 includes a strain gauge type load cell for calculating a force from a change in electric resistance caused by a metallic strain. When force P along the flow of cooling air 7 is applied to filter 2, the magnitude of force P can be detected by force detector 11.

When cooling air 7 passes through filter 2, filter 2 starts to resist the flow of cooling air 7, whereby force P is applied to filter 2. The magnitude of force P is different depending on the coarseness of the mesh of filter 2, that is, the clogging state of filter 2.

In a state in which the dust is not deposited on filter 2, the air resistance of filter 2 is comparatively small and hence force P that is applied to filter 2 by cooling air 7 is also comparatively small. As the amount of dust deposited on filter 2 increases, the flow resistance of filter 2 also increases and hence force P that is applied to filter 2 by cooling air 7 becomes larger.

Thus, by detecting the magnitude of force P that is applied to filter 2 by cooling air 7 by the use of force detector 11, the clogging state of filter 2 can be recognized.

Further, the filter clogging detection apparatus in the first exemplary embodiment is provided with clogging determination part 12 determining that filter 2 has become clogged upon receiving a detection signal from force detector 11. When a value detected by force detector 11 becomes larger than a predetermined threshold, clogging determination part 12 determines that clogging of filter 2 has occurred.

The predetermined threshold is a value of air pressure that filter 2 receives from cooling air 7 in a state in which the air resistance of filter 2 increases and in which the flow rate of cooling air 7 hence decreases to thereby make it impossible to sufficiently cool object 6 that is to be cooled. The predetermined threshold is experimentally found in advance and is stored in clogging determination part 12.

When clogging of filter 2 occurs, clogging determination part 12 takes measures such as sounding an alarm (not shown) and stopping the operation of the heating part. By sounding the alarm, an operator can be alerted that it is necessary to replace filter 2. Further, by stopping the operation of the heating part, clogging filter 2 can be prevented from causing the electronic instrument overheat.

According to the present invention, even in the state in which a face of filter 2 is not arranged in a horizontal direction, for example, a state in which a face for preventing dust from entering filter is arranged parallel to a vertical direction, force P that is applied to filter 2 by cooling air 7, according to the amount of dust deposited on filter 2, can be measured. In other words, the clogging of filter 2 can be detected without being limited in a direction in which filter 2 takes in cooling air 7.

### Exemplary Embodiment 2

Next, a filter clogging detection apparatus in a second exemplary embodiment of the present invention will be described.

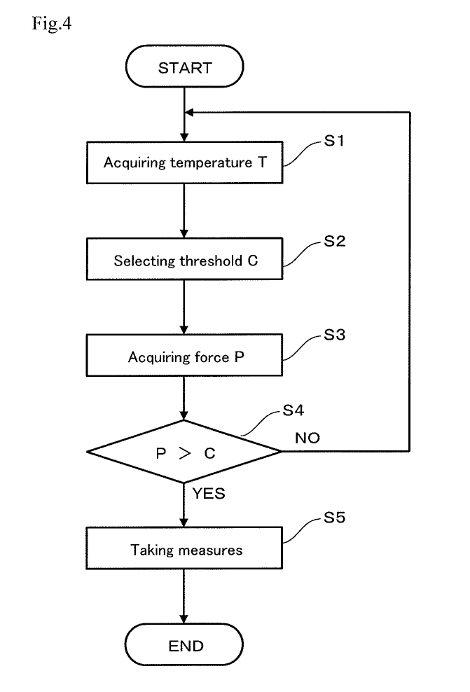

FIG. 3 is a schematic view of an electronic instrument having a filter clogging detection apparatus in the second exemplary embodiment. As shown in FIG. 3, the filter clogging detection apparatus in the second exemplary embodiment includes fan 10, filter 2, force detector 11, and clogging determination part 12, and has basically the same construction as the first exemplary embodiment.

In addition to the first exemplary embodiment, the filter clogging detection apparatus in the second exemplary embodiment is provided with temperature detector 13 on the upstream side in a direction of the flow of cooling air 7 with respect to object 6 to be cooled. The temperature of cooling air 7 before the cooling air hits object 6 that is to be cooled (hereinafter referred to as “cooling air temperature T”) can be detected.

Further, the filter clogging detection apparatus in the second exemplary embodiment is provided with a threshold selection part 14 selecting predetermined threshold C used by clogging determination part 12 from cooling air temperature T detected by temperature detector 13.

Here, the relationship between cooling air temperature T and threshold C will be described.

When cooling air temperature T is comparatively low, even if the flow rate of cooling air 7 is comparatively small, object 6 to be cooled can be sufficiently cooled. As cooling air temperature T becomes higher, the flow rate of cooling air 7 that is necessary for cooling object 6 to be cooled increases.

Further, when fan 10 is rotated at a constant number of revolutions, the flow rate of cooling air 7 is changed according to the amount of dust deposited on filter 2. As the amount of dust deposited on filter 2 increases, the flow rate of cooling air 7 decreases.

Hence, when cooling air temperature T is high, it is necessary to increase the flow rate of cooling air 7 and thus filter 2 needs to be replaced when it reaches a state in which the amount of dust deposited on it is smaller than when cooling air temperature T is low. In contrast, when cooling air temperature T is low, even if the amount of dust deposited on filter 2 is larger as compared with a case where cooling air temperature T is high, filter 2 can be used continuously.

In other words, when cooling air temperature T is low, by selecting larger threshold C as compared with a case where cooling air temperature T is high, an replacement frequency for replacing filter 2 can be decreased and hence the cost of filter 2 can be reduced.

A plurality of thresholds C based on which clogging determination part 12 determines that the clogging of filter 2 is caused are experimentally found in advance according to cooling air temperature T and are stored in threshold selection part 14. One of the plurality of thresholds C stored in threshold selection part 14 is selected from the temperature detected by temperature detector 13 and is used for clogging determination part 12.

By selecting threshold C according to the value of cooling air temperature T, the cost of filter 2 can be inhibited and the overheating of the electronic instrument by the clogging of filter 2 can be prevented.

Next, the operation of the filter clogging detection apparatus in the second exemplary embodiment will be described by the use of FIG. 4. FIG. 4 is a flow chart to show an operation of the filter clogging detection apparatus in the second exemplary embodiment.

First, in step 1 (hereinafter, a step is referred to as “S”), cooling air temperature T before cooling air 7 hits object 6 to be cooled is acquired by the use of temperature detector 13 and threshold C responsive to cooling air temperature T is selected by threshold selection part 14 (S2).

Next, force P that filter 2 receives from cooling air 7 at the present time is acquired by the use of force detector 11 (S3). Further, when force P at the present time is larger than threshold C corresponding to cooling air temperature T at the present time, clogging determination part 12 determines that the clogging of filter 2 has occurred (S4) and takes measures such as sounding an alarm or stopping the operation of the heating part (S5). When clogging of filter 2 does not occur, the process returns to S1 where cooling air temperature T is again acquired.

As described above, the clogging of filter 2 can be detected by the clogging detection apparatus in the second exemplary embodiment without being limited in a direction in which the cooling air 7 is taken in. Further, the clogging of filter 2 can be determined according to cooling air temperature T and hence the electronic instrument can be prevented from being overheated and the cost of filter 2 can be reduced.

The present invention has been described above with reference to the exemplary embodiments, but the present invention is not limited to the exemplary embodiments described above. Various modifications understood by a person skilled in the art can be made to configuration and details of the present invention within the scope of the technical ideas of the present invention.

### INDUSTRIAL APPLICABILITY

The present invention can be applied to a unit, which has a closed case except for a gas suction port and a gas discharge port for a cooling gas and has a heating body in the case and sucks the cooling gas from the outside and requires that the cooling gas be cleaned.

### DESCRIPTION OF REFERENCE NUMERALS AND SIGNS

1 cylinder part

2 filter

3 helix spring

4 switch

5 case

6 object to be cooled

7 cooling air

8 air suction port

9 air discharge port

10 fan

11 force detector

12 clogging determination part

13 temperature detector

14 threshold selection part

C threshold

P force

T cooling air temperature

What is claimed is:

1. A filter clogging detection apparatus for detecting clogging in a filter for preventing dust contained in a cooling air for cooling an object to be cooled from passing through the filter, comprising:
a force detector fixed to a case in such a way as to abut on a face on a downstream side in a direction of flow of the cooling air of the filter, and detecting a force applied to the filter when the cooling air passes through the filter; and
a clogging determination part determining that clogging is caused in the filter when a value detected by the force detector is larger than a predetermined threshold.

2. The filter clogging detection apparatus according to claim 1, comprising:
a temperature detector detecting a temperature of the cooling air before hitting the object to be cooled; and
a threshold selection part storing a plurality of thresholds by which the clogging determination part determines that clogging is caused in the filter, and selecting one threshold from among a plurality of thresholds based on the temperature detected by the temperature detector to make the selected threshold the predetermined threshold.
